(19) United States
(12) Patent Application Publication
(10) Pub. No.: US 2009/0129318 A1
(43) Pub. Date: May 21, 2009

(54) METHOD, SYSTEM AND APPLICATION SERVER FOR ROUTING CS DOMAIN CALLS TO PS DOMAIN

(76) Inventors: Jie Xu, Shenzhen (CN); Yan Li, Shenzhen (CN)

Correspondence Address: BRINKS HOFER GILSON & LIONE, P.O. BOX 10395, CHICAGO, IL, 60610, US

(21) Appl. No.: 12/356,986

(22) Filed: Jan. 21, 2009

Related U.S. Application Data
(63) Continuation of application No. PCT/CN2007/002265, filed on Jul. 26, 2007.

(30) Foreign Application Priority Data
Aug. 1, 2006 (CN) 200610106815.3

(51) Int. Cl. H04W 8/02; H04L 12/66; H04W 4/00; H04W 40/00

(52) U.S. Cl. 370/328; 370/352; 455/445

(57) ABSTRACT

A method and system for routing a Circuit Switched (CS) domain call to a Packet Switched (PS) domain are disclosed. The method includes a Voice Call Continuity Application Server (VCC AS) in the PS domain interacts with a Home Location Register (HLR) in the CS domain to obtain an original called number, allocates a PS domain routing number to a CS domain call, and originates a corresponding PS domain call according to the obtained original called number after the PS domain call, which uses the PS domain routing number as a called party identifier, arrives at the VCC AS in the PS domain. The VCC AS obtains the call information through the interaction with the HLR rather than the interaction with a Service Control Point (SCP). Therefore, a Mobile Switching Center (MSC) needs to communicate with the HLR only, without the requirement to communicate with the SCP, and the MSC in the present disclosure does not need to support intelligent processing.

This application is a continuation application of PCT/CN2007/002265, filed on Jul. 26, 2007, which claims priority to Chinese Patent Application No. 200610106815.3, filed on Aug. 1, 2006, both of which are incorporated herein by reference in their entirety.

### FIELD OF THE DISCLOSURE

The present disclosure relates to the communication field, and in particular, to a method, system, and application server for routing a Circuit Switched (CS) domain call to the Packet Switched (PS) domain.

### BACKGROUND OF THE DISCLOSURE

With the emergence of advanced PS technologies, the PS networks based on the packet switched technologies have develop rapidly, and the traditional CS networks based on the circuit switched technologies are fading out. However, a PS network may coexist with a CS network. In this case, the calls in the traditional CS network need to be forwarded to the PS domain network for controlling. For example, a dual-mode Mobile Station (MS) which supports both CS network access and PS network access performs a service in the two types of networks. When the MS initiates a handover from the CS domain to the PS domain during a conversation, the service provider normally controls the MS to handle the service in the two types of networks by inserting an entity based on the PS network into the call path of the MS. For a traditional MS within the CS domain, the service provider may use the PS network to manage the calls of the MS uniformly for the purpose of saving costs. Therefore, the calls of the MS in the CS domain need to be forwarded to the PS network.

Moreover, the intelligent network protocol for Code Division Multiple Access (CDMA) defines a method for a user home network entity—Home Location Register (HLR) to trigger intelligent logics to the Service Control Point (SCP) in place of the visited network to perform service control in the case when the visited network does not support intelligent processing. The call origination process and the call termination process in such a scenario are described below.

FIG. 1 shows the call origination process when the visited network does not support intelligent processing. The process includes:

The Mobile Switching Center (MSC), which serves the user, detects that the user originates a call and triggers the Origination Trigger (ORIGTRIG) presubscribed by the user and sends an Origination Request (ORREQ) signaling to the HLR.

According to the received ORREQ signaling (the received ORREQ signaling contains no parameter that identifies the intelligent processing capability of the MSC or contains a parameter that explicitly indicates that the MSC does not support intelligent processing), the HLR determines that the user is an intelligent user and the MSC does not support intelligent processing. Then the HLR replaces the MSC to forward the ORREQ signaling to the subscribed SCP by the user.

After receiving the ORREQ signaling, the SCP performs service control and then returns corresponding service control results (continue the call, terminate the call, play an announcement to the user, or redirect the call, etc.). The service control results are forwarded to the MSC through the HLR. After receiving the service control results, the MSC performs subsequent operations according to the service control results.

FIG. 2 shows the call termination process when the visited network does not support intelligent processing. The process includes:

The originating MSC receives a request for calling the called party and sends a Location Request (LOCREQ) signaling to the HLR of the called party, requesting to query for the location of the called party.

According to the received LOCREQ signaling (the received LOCREQ signaling contains no parameter that identifies the intelligent processing capability of the MSC or contains a parameter that explicitly indicates that the MSC does not support intelligent processing), the HLR of the called party determines that the called party is an intelligent user but the MSC that transmits the signaling message does not support intelligent processing. Then the HLR of the called party replaces the MSC to send a Service Request (SERVREQ) signaling to the SCP, requiring the SCP to perform service control.

After receiving the SERVREQ signaling, the SCP performs service control according to the subscription data of the user and returns the corresponding service control results (continue the call, terminate the call, or redirect the call, etc.) to the HLR. The HLR returns a response to the MSC according to the control results returned by the SCP. Upon receiving the response, the MSC performs subsequent operations according to the control results in the response.

The prior art provides a method for routing a CS domain call to the PS domain based on the 3GPP2 standard. The method requires the network to support intelligent network processing. As shown in FIG. 3, the method in the prior art includes the following steps:

The user originates a call in the CS domain. The Mobile Switching Center/Visitor Location Register (MSC/VLR) triggers the call control signaling ORREQ to an intelligent control entity WIN SCP by means of intelligent triggering. The WIN SCP forwards the ORREQ message to a control entity in the PS network—Voice Call Continuity Application Server (VCC AS).

The VCC AS records the original called number of the user, modifies the called number to the Internet Protocol (IP) Multimedia Subsystem (IMS) domain access number, and returns the IMS domain access number to the WIN SCP. The WIN SCP forwards the response returned by the VCC AS to the MSC.

According to the received IMS domain access number, the MSC routes the call to the ingress Media Gateway Control Function (MGCF) of the IMS domain.

The MGCF constructs a SIP session addressed to the IMS domain routing number and triggers the SIP session to the VCC AS through an Interrogating Call Session Control Function (I-CSCF).

After receiving the session, the VCC AS initiates a new session in the IMS domain in which the destination address of the session is the original called number stored previously.

After completion of the foregoing steps, the CS domain call is routed to the IMS domain, and the called number is recovered. Afterward, each AS in the IMS domain can perform service control on the called number.

As seen from the prior art, the MSC triggers the call originated by the user in the CS domain to the VCC AS by means of intelligent triggering. This requires the MSC to support intelligent network processing, thus raising the costs of upgrade and maintenance of the network equipment.

### SUMMARY OF THE DISCLOSURE

The present disclosure provides a method for routing a CS domain call to the PS domain. The method includes a VCC AS in the PS domain that obtains an original called number through interacting with the HLR in the CS domain and allocates a PS domain routing number for the CS domain call. When a PS domain call, which uses PS domain routing number as a called party identifier, arrives at the VCC AS in the PS domain, the VCC AS in the PS domain originates a corresponding PS domain call according to the obtained original called number.

The present disclosure provides a system for routing a CS domain call to the PS. The system includes a VCC AS in the PS domain adapted to interact with the HLR in the CS domain to obtain the original called number, allocate a PS domain routing number to the CS domain call, and originate a corresponding PS domain call according to the obtained original called number after the PS domain call, which uses the PS domain routing number as the called party identifier, arrives at the VCC AS in the PS domain and an HLR in the CS domain adapted to send the original called number corresponding to the CS domain call to the VCC AS in the PS domain and send the PS domain routing number allocated by the VCC AS in the PS domain to the CS domain.

An embodiment of the present disclosure provides a VCC AS for routing a CS domain call to the PS domain that includes a call control unit adapted to receive information sent by the HLR in the CS domain, obtain the original called number from the information, allocate a corresponding PS domain routing number to the CS domain call, and originate a corresponding PS domain call according to the obtained original called number after the PS domain call, which uses the PS domain routing number as the called party identifier, arrives and a transmission unit adapted to transfer the PS domain call originated by the call control unit.

As seen from the technical solution of the present disclosure, the VCC AS in the PS domain interacts with the HLR in the CS domain to obtain the original called number and allocates a PS domain routing number to the CS domain call. Therefore, the VCC AS can originate a new SIP session according to the obtained original called number after the CS domain call arrives at the VCC AS in the PS domain by the PS domain routing number. The VCC AS obtains the call information through the interaction with the HLR rather than the interaction with the SCP. Therefore, the MSC needs to communicate with the HLR only, without the requirement to communicate with the SCP. The MSC in the present disclosure does not need to support intelligent processing.

### BRIEF DESCRIPTION OF THE DRAWINGS

FIG. 1 shows the call origination process when the visited network does not support intelligent processing in the prior art;

FIG. 2 shows the call termination process when the visited network does not support intelligent processing in the prior art;

FIG. 3 shows the process of routing a CS domain call to the PS domain when the network supports intelligent processing in the prior art;

FIG. 4 is a flowchart of a first embodiment of the present disclosure;

FIG. 5 is a flowchart of a second embodiment of the present disclosure;

FIG. 6 is a block diagram of a third embodiment of the present disclosure; and

FIG. 7 is a block diagram of a fifth embodiment of the present disclosure.

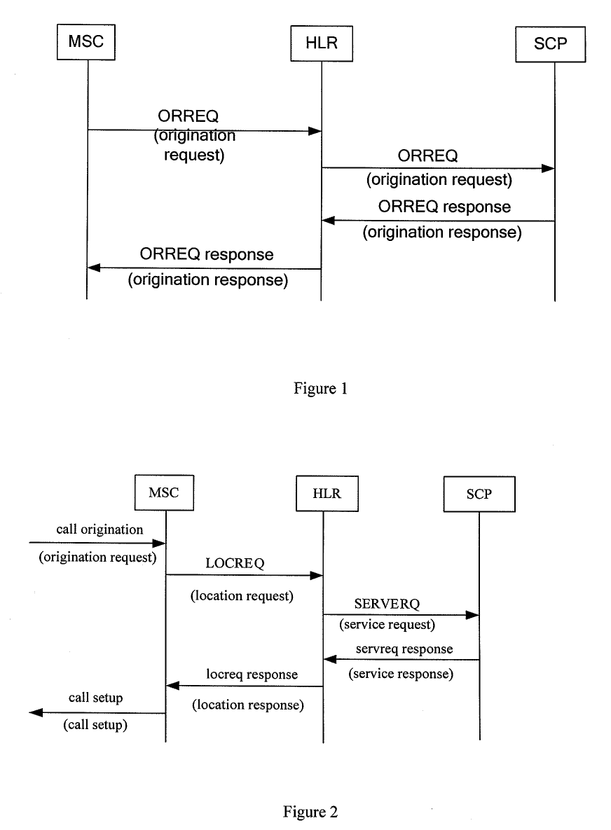

### DETAILED DESCRIPTION OF THE EMBODIMENTS

In an embodiment of the present disclosure, a Voice Call Continuity Application Server (VCC AS) in a Packet Switched (PS) domain (for example, an IMS domain) receives a Circuit Switched (CS) domain call control signaling sent by a Home Location Register (HLR), stores the original called number corresponding to the call, and returns a PS domain routing number (for example, IMS domain routing number) so that the call is routed from the CS domain to the PS domain (for example, an IMS domain entity). The PS domain (for example, an IMS domain) initiates a new PS domain call (for example, a SIP session) according to the previously stored original called number after receiving the call signaling.

The first embodiment of the present disclosure provides a call origination process of routing a CS domain call to the PS domain. In a CDMA2000 network, after the calling party originates a call in the CS domain, the VCC AS in the PS domain interacts with the HLR in the CS domain to obtain the original called number, allocates a corresponding PS domain routing number for the call, and returns the PS domain routing number to the MSC in the CS domain through the HLR in the CS domain. After the MSC routing the call in the CS domain to the PS domain according to the PS domain routing number, the VCC AS in the PS domain originates a new PS domain call (such as SIP session) according to the obtained original called number. As shown in FIG. 4, the detailed process includes the following steps:

Step 501: The calling party originates a call in the CS domain, and the called number is the number of another terminal MS2.

Step 502: After determining that the calling party has subscribed to the Origination Trigger (ORIGTRIG) service by the MSC (with or without intelligent processing capability) serving for the user, the MSC triggers an ORREQ control signaling to the HLR of the calling party.

Step 503: After receiving the ORREQ control signaling, the HLR determines that the user has subscribed a special service, and hence sends the call-related information such as the original called number to the PS domain (e.g. the VCC AS) to which the user subscribes through a call control signaling. Meanwhile, the HLR requests the VCC AS to allocate a PS domain routing number, for example, IMS domain routing number.

The call control signaling may be a Mobile Application Protocol (MAP) signaling forwarded by the HLR such as ORREQ or may be other type signaling such as Diameter signaling and CAMEL Application Part (CAP) signaling, in which CAMEL stands for Customized Application for Mobile network Enhanced Logic, as long as the HLR can bring the call-related information such as the original user number to the VCC AS and can request the VCC AS to allocate a PS domain routing number, for example, IMS domain routing number.

Step 504: After receiving the call control signaling (such as ORREQ signaling), the VCC AS stores the original called number in the call control signaling and the information related to the call control signaling such as calling number or routing information.

Step 505: The VCC AS returns a response with the PS domain routing number such as IMS domain routing number to the HLR, instructing the HLR to perform call redirection.

Step 506: The HLR forwards the response sent by the VCC AS to the MSC.

Step 507: According to the received response, the MSC obtains the PS domain routing number such as IMS domain routing number. According to the PS domain routing number, the MSC routes the call of the calling party to the PS domain, for example, the ingress network element of the IMS domain—Media Gateway Control Function (MGCF).

Step 508: By using the PS domain routing number (such as IMS domain routing number) as a destination address, the MGCF originates a new PS domain call (such as SIP session) in the PS domain such as IMS domain. Afterward, through the PS domain call signaling, the MGCF sends the PS domain call to the VCC AS of the PS domain.

Alternatively, the new PS domain call signaling may be forwarded to the VCC AS of the PS domain through the I-CSCF or S-CSCF entity.

Step 509: After receiving the PS domain call signaling, the VCC AS correlates with the stored original called number according to the PS domain call signaling and originates a new PS domain call (such as SIP session) in the PS domain by using the stored original called number as a destination address.

The VCC AS may correlate with the stored original called number according to the calling number carried in the PS domain call signaling or according to the information related to the call control signaling (such as calling number or routing information).

The second embodiment of the present disclosure provides a call termination process in a second method for routing a CS domain call to the PS domain. In a CDMA2000 network, when a CS domain call arrives at the MSC, the MSC requests the location of the called party from the HLR in the CS domain of the called party. The HLR in the CS domain sends the original called number to the VCC AS in the PS domain. The VCC AS returns the corresponding PS domain routing number according to the original called number. After the MSC routes the CS domain call to the PS domain according to the PS domain routing number, the VCC AS in the PS domain originates a new PS domain call (such as SIP session) according to the obtained original called number. As shown in FIG. 5, the detailed process includes the following steps:

Step 601: The CS domain call arrives at the MSC, with the called number being the number of the called party MS2. The MSC may be a serving MSC in the originating network or an MSC in the terminating network. The MSC may be incapable or capable of intelligent processing.

Step 602: The MSC sends a Location Request (LOCREQ) call control signaling to the HLR of the called party, requesting to query the route of the called party.

Step 603: After receiving the LOCREQ call control signaling, the HLR determines that the called party has subscribed a special control service, and hence sends a Service Request (SERVREQ) to the PS domain (such as VCC AS) to which the user subscribed, so as to perform service control. Alternatively, the HLR may use other MAP signaling. For example, the HLR may forward a LOCREQ to the VCC AS directly, send a Routing Request (ROUTREQ) message to the VCC AS, or use other type signaling such as CAP signaling and Diameter signaling to bring the original call information to the VCC AS. The HLR also requests a PS domain routing number (such as IMS domain routing number) from the VCC AS.

Step 604: After receiving the call control signaling sent by the HLR, the VCC AS stores the original called number in the call control signaling and the information related to the call control signaling such as calling number or routing number. The VCC AS also allocates a corresponding PS domain routing number (such as IMS domain routing number) for the call.

Step 605: The VCC AS returns a response with the PS domain routing number such as IMS domain routing number to the HLR.

Step 606: The HLR forwards the response to the MSC.

Step 607: After receiving the response, the MSC retrieves the PS domain routing number such as IMS domain routing number from the response. According to the PS domain routing number, the MSC routes the call (such as initial address message) to the PS domain, for example, the ingress network element of the IMS domain—MGCF.

Step 608: By using the PS domain routing number (such as IMS domain routing number) as a destination address, the MGCF originates a new PS domain call (such as SIP session) in the PS domain such as IMS domain. Afterward, through the PS domain call signaling, the MGCF sends the PS domain call to the VCC AS of the PS domain.

Alternatively, the new PS domain call signaling may be forwarded to the VCC AS of the PS domain through the I-CSCF or S-CSCF entity.

Step 609: After receiving the PS domain call signaling, the VCC AS correlates with the stored original called number according to the PS domain call signaling, and originates a new PS domain call (such as SIP session) in the PS domain by using the stored original called number as a destination address.

The VCC AS may correlate with the stored original called number according to the calling number carried in the PS domain call signaling or according to the information related to the call control signaling (such as calling number or routing information).

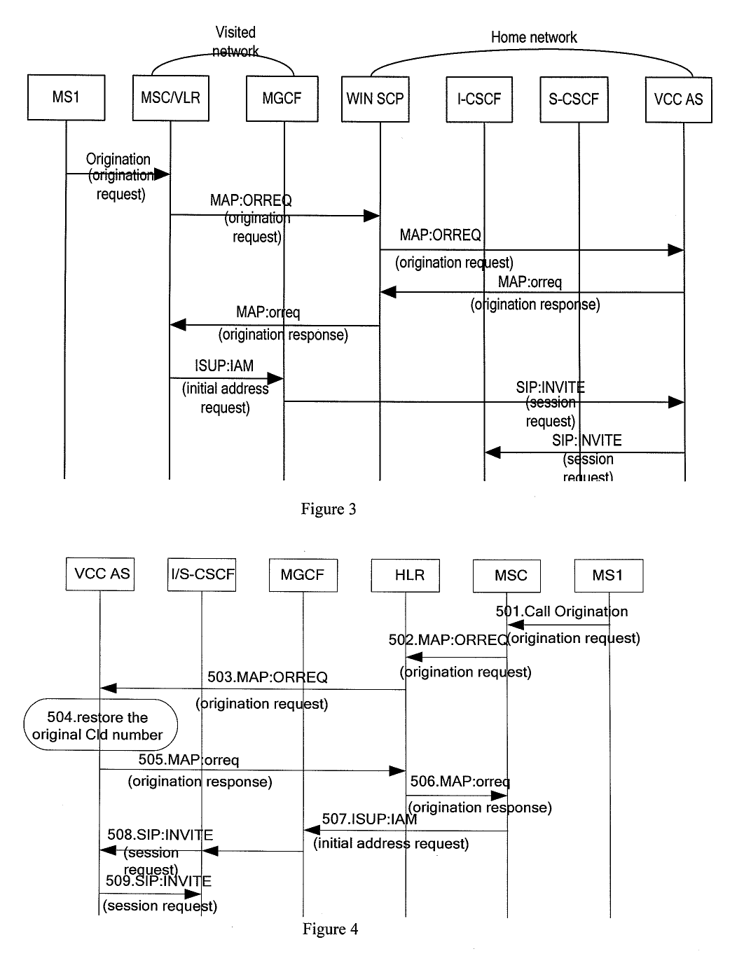

The first and second embodiments of the present disclosure (as shown in FIG. 4 and FIG. 5) describe the process when the VCC AS is combined with the SCP. In actual networking, the VCC AS may be combined with the SCP or be an independent device. If the VCC AS is an independent device separated from the SCP, the messages between the HLR and the VCC AS (such as ORREQ and SERVREQ) are forwarded through an intermediate SCP (the mechanism is similar to that as shown in FIG. 3).

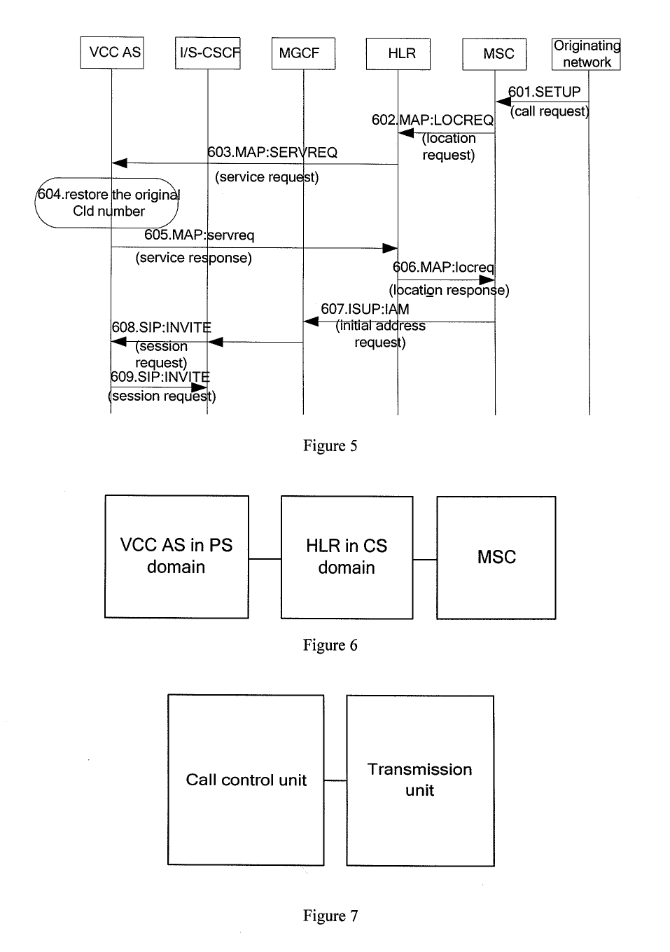

The third embodiment of the present disclosure provides a system for routing a CS domain call to the PS domain. As shown in FIG. 6, the structure of the system includes a VCC AS in the PS domain, an HLR, and an MSC in the CS domain. The HLR contains a signaling constructing unit and a signaling transmission unit. The MSC may or may not have the capability of intelligent network processing.

The MSC sends the corresponding call control signaling to the HLR in the CS domain according to the call of the user.

After receiving the call control signaling, the HLR encapsulates the original called number into the MAP, Diameter, or CAP signaling through the signaling constructing unit and sends the signaling constructed by the signaling constructing unit to the VCC AS in the PS domain through the signaling transmission unit.

The VCC AS in the PS domain retrieves the original called number from the information sent by the HLR in the CS domain, allocates the corresponding PS domain routing number to the call, and returns the PS domain routing number to the HLR.

The HLR in the CS domain transfers the PS domain routing number to the MSC.

According to the PS domain routing number, the MSC routes the CS domain call to the PS domain.

After receiving the call, the VCC AS in the PS domain correlates with the original called number of the call according to the stored original called number and originates a new PS domain call (such as SIP session) according to the correlated original called number.

The fourth embodiment of the present disclosure provides another system for routing a CS domain call to the PS domain. Compared with the third embodiment, the system in the fourth embodiment contains no MSC but contains a VCC AS in the PS domain and an HLR in the CS domain. The HLR includes a signaling constructing unit and a signaling transmission unit.

After receiving the CS domain call control signaling, the HLR encapsulates the original called number into the MAP, Diameter, or CAP signaling through the signaling constructing unit and sends the signaling constructed by the signaling constructing unit to the VCC AS in the PS domain through the signaling transmission unit.

The VCC AS in the PS domain retrieves the original called number from the information sent by the HLR in the CS domain, allocates the corresponding PS domain routing number to the call, and returns the PS domain routing number to the HLR.

The HLR in the CS domain transfers the PS domain routing number to the CS domain.

After the PS domain call which uses the PS domain routing number as a called party identifier arrives at the VCC AS in the PS domain, the VCC AS in the PS domain correlates with the original called number of the call according to the stored original called number and originates a new PS domain call (such as SIP session) according to the correlated original called number.

The fifth embodiment of the present disclosure provides a VCC AS for routing a CS domain call to the PS domain. As shown in FIG. 7, the VCC AS includes a call control unit and a transmission unit.

The call control unit is adapted to receive the information sent by the HLR in the CS domain, obtain the original called number from the information, allocate a corresponding PS domain routing number to the CS domain call, correlate with the obtained original called number according to the PS domain call after the PS domain call which uses the PS domain routing number as the called party identifier arrives, and originate a new PS domain call by using the original called number as a destination address. The transmission unit is adapted to transfer the PS domain call originated by the call control unit.

After a correlation is made to the obtained original called number according to the PS domain call, the VCC AS may correlate with the stored original called number according to the calling number carried in the PS domain call signaling or according to the information such as PS domain routing number.

The foregoing method, system, and apparatus take the CDMA2000 network as an example, and the embodiments of the present disclosure are also applicable to the WCDMA network. If the present disclosure is applied to a WCDMA network, the call control signaling should be replaced with the corresponding signaling in the WCDMA network. For example, in the second embodiment, the call control signaling of the Location Request (LOCREQ) should be replaced with the Send_Routing_Info (SRI) control signaling applied to the WCDMA network.

As seen from the preceding embodiments, the VCC AS in the PS domain interacts with the HLR in the CS domain to obtain the original called number. Therefore, after the CS domain call arrives at the VCC AS in the PS domain according to the PS domain routing number, the VCC AS can originate a new SIP session according to the obtained original called number. The VCC AS obtains the call information through the interaction with the HLR rather than the interaction with the SCP so the MSC needs to communicate with the HLR only, without the need of communicating with the SCP. The MSC in the present disclosure does not need to support intelligent processing.

Although the disclosure has been described through some exemplary embodiments, the disclosure is not limited to such embodiments. It is apparent that those skilled in the art can make various modifications and variations to the present disclosure without departing from the spirit and scope of the present disclosure. The present disclosure is intended to cover these modifications and variations provided that they fall in the scope defined by the following claims or their equivalents.

What is claimed is:

1. A method for routing a Circuit Switched (CS) domain call to a Packet Switched (PS) domain, comprising:
obtaining, by a Voice Call Continuity Application Server (VCC AS) in the PS domain, original called number through interacting with a Home Location Register (HLR) in the CS domain;
allocating, by the VCC AS, a PS domain routing number for the CS domain call; and
originating, by the VCC AS, a corresponding PS domain call according to the obtained original called number when a PS domain call using the PS domain routing number as a called party identifier arrives at the VCC AS.

2. The method according to claim 1, wherein, the obtaining, by the V CC AS, original called number through interacting with the HLR comprises:
when the user corresponding to the call has subscribed a special service, sending, by the HLR, the original called number to the VCC AS; and
obtaining, by the VCC AS, the original called number sent by the HLR.

3. The method according to claim 2, wherein, the sending the original called number to the VCC AS in the PS domain further comprises:
returning, by the VCC AS, the PS domain routing number to the Mobile Switching Center (MSC) in the CS domain;
routing, by the MSC, the CS call to a Media Gateway Control Function (MGCF) in the PS domain according to the PS domain routing number; and
originating, by the MGCF, a PS domain call in the PS domain according to the CS domain call, and sending the PS domain call to the VCC AS, wherein the PS domain call uses the PS domain routing number as a destination address.

4. The method according to claim 3, comprising:
carrying, by the PS domain call, at least one of the calling number and the PS domain routing number.

5. The method according to claim 1, wherein, the originating, by the VCC AS, a corresponding PS domain call according to the obtained original called number when a PS domain call using the PS domain routing number as the called party identifier arrives at the VCC AS, comprises:
correlating, by the VCC AS, with the original called number according to the PS domain call, and
originating, by the VCC AS, a new PS domain call in the PS domain by using the obtained original called number as a destination address.

6. The method according to claim 5, wherein, the correlating, by the VCC AS, with the stored original called number according to the PS domain call comprises:
correlating, by the VCC AS, with the original called number according to the calling number carried in the PS domain call using a PS domain routing number as the called party identifier;
or
correlating, by the VCC AS, with the original called number according to the PS domain routing number carried in the PS domain call using the PS domain routing number as the called party identifier.

7. The method according to claim 3, wherein, the method further comprises:
originating, by the calling party, the call in the CS domain; and
sending, by the MSC serving for the calling party, an ORREQ signaling to the HLR of the calling party.

8. The method according to claim 3, wherein, the method further comprises:
receiving, by the MSC, the CS domain call, and
sending, by the MSC, a Location Request to the HLR of the called party.

9. The method according to claim 1, wherein, the PS domain routing number is an IMS, IP Multimedia Subsystem, or domain routing number.

10. A system for routing a Circuit Switched (CS) domain call to a Packet Switched (PS) domain, comprising:
a Voice Call Continuity Application Server (VCC AS) in the PS domain adapted to obtain an original called number by interacting with a Home Location Register (HLR) in the CS domain, allocate a PS domain routing number for the CS domain call, and when a PS domain call using PS domain routing number as a called party identifier arrives at the VCC AS, originate a corresponding PS domain call according to the obtained original called number.

11. The system according to claim 10, further comprising:
a Mobile Switching Center (MSC) adapted to send a call control signaling to the HLR in the CS domain according to the CS domain call, receive the PS domain routing number from the HLR, and route the CS domain call to the PS domain according to the PS domain routing number.

12. The system according to claim 11, wherein, the MSC has capability of intelligent network processing.

13. The system according to claim 11, wherein, the MSC has no capability of intelligent network processing.

14. The system according to claim 10, wherein the HLR comprises:
a signaling constructing unit adapted to encapsulate the original called number into a MAP signaling, Diameter signaling, or CAP signaling; and
a signaling transmission unit adapted to send the signaling constructed by the signaling constructing unit to the VCC AS in the PS domain.

15. The system according to claim 10, wherein, the PS domain routing number is IMS, IP Multimedia Subsystem, or domain routing number.

16. A Home Location Register (HLR), comprising:
a signaling constructing unit adapted to encapsulate an original called number into a Mobile Application Protocol (MAP) signaling, a Diameter signaling, or a CAMEL Application Part (CAP) signaling; and
a signaling transmission unit adapted to send the signaling constructed by the signaling constructing unit to a Voice Call Continuity Application Server (VCC AS) in a Packet Switched (PS) domain.

17. A Voice Call Continuity Application Server (VCC AS), comprising:
a call control unit adapted to receive information sent by a Home Location Register (HLR) in the Circuit Switched (CS) domain, obtain an original called number from the information, allocate a corresponding Packet Switched (PS) domain routing number to the CS domain call, and after a PS domain call using the PS domain routing number as a called party identifier arrives, originate a new PS domain call by using the original called number; and
a transmission unit adapted to transfer the PS domain call originated by the call control unit.

18. The VCC AS according to claim 17, wherein, the PS domain routing number is an IMS, Internet Protocol (IP) Multimedia Subsystem, or domain routing number.
